(19) United States
(12) Patent Application Publication
(10) Pub. No.: US 2026/0178436 A1
(43) Pub. Date: Jun. 25, 2026

(54) LOCAL INTERFACE ERROR RECOVERY FOR NODE-TO-NODE TRANSFERS IN MESH NETWORK ON AN INTEGRATED CIRCUIT (IC) AND RELATED METHODS

(71) Applicant: Microsoft Technology Licensing, LLC, Redmond, WA (US)

(72) Inventors: Salaj NEWATIA, Raleigh, NC (US); Thomas BASNIGHT, Raleigh, NC (US); Venkata Ravichandra RAVI, Cary, NC (US)

(21) Appl. No.: 18/991,086

(22) Filed: Dec. 20, 2024

(51) Int. Cl. G06F 11/14; H04L 67/10

(52) U.S. Cl. CPC G06F 11/0793; G06F 11/0721

(57) ABSTRACT

A mesh network in an integrated circuit (IC) may transfer a data packet from a source node to a destination node through many node-to-node interfaces. When an error occurs, resetting the IC can have a significant performance impact. An IC including nodes interconnected in a mesh network may employ a transmit control circuit coupled to a transmit node and a receive control circuit coupled to a receive node to reinitialize interface circuits on both ends of a node-to-node interface in response to a detected error in either a transmit node or a receive node. This allows the IC to correct the error and continue to operate the rest of the IC while the node interface is reinitialized rather than resetting the entire IC. For example, errors that can trigger a node to be reinitialized may be in interface circuits, flow control circuits, or data packets.

### FIELD OF THE DISCLOSURE

The technology of the disclosure relates, in general, to transferring data between circuits on an integrated circuit (IC), and more particularly to mechanisms for recovering from errors in tracking such transfers.

### BACKGROUND

Integrated circuits (ICs), such as system-on-chip (SoC) ICs, may have complex communication networks, referred to as mesh networks, to transfer data between nodes that include processing circuits. Transferring data from a source node to a destination node may require passing the data through intermediate nodes with data transfers through multiple node-to-node interfaces. One type of protocol used for the transfer of data packets in such interfaces is based on a receiver node providing credits to a sender node to indicate a number of transfers that the receiver node can accept. The credits may be placeholders for data packets that can be stored in the buffer space available in the receiver node. The credits indicate that the sender node is allowed to transmit, to the receiver node, a number of data packets equal to the number of credits without further communication. Once the initial credits are consumed, the sender node waits to receive more credits from the receiver node before transmitting any more data packets. The sender node and the receiver node each track the number of credits provided to the sender node and the number of data transfers from the sender node to the receiver node. Errors in tracking of the credit/transfer information in either the sender node or the receiver node can cause a loss of data or reduce system performance. Errors may also occur in the data packets and in state machines that manage the transfer of data packets. When such errors are determined to be unrecoverable, the IC may be rebooted to restore normal operation. A reboot of the IC resets all nodes in the mesh network, significantly impacting performance of the IC and the device in which it operates.

### SUMMARY

Exemplary aspects disclosed herein include local interface error recovery for node-to-node transfers in a mesh network on an integrated circuit (IC). Related methods of recovering from errors in node-to-node transfer interfaces are also disclosed. A mesh network in an IC may transfer a data packet from a source node to a destination node through many node-to-node interfaces. When an error occurs in one node-to-node interface, it may be possible to reroute a data packet around the problematic interface, but the interface may remain unusable until the entire IC is reset, reducing overall performance. However, resetting the IC can have a much greater performance impact. An exemplary IC including nodes interconnected in a mesh network may employ a transmit control circuit coupled to a transmit node and a receive control circuit coupled to a receive node to reinitialize interface circuits on both ends of a node-to-node interface in response to a detected error in either a transmit node or a receive node. This allows the IC to correct the error and continue to operate the rest of the IC while the node interface is reinitialized rather than resetting the entire IC. In some examples, errors that can trigger a node to be reinitialized may be in circuits that move the data packets within a node, circuits that control flow of the data packets between nodes, or in data packets themselves.

In one exemplary aspect, an integrated circuit (IC), including a plurality of nodes interconnected in a mesh network, is disclosed. The IC further includes a first node of the plurality of nodes coupled to a first node-to-node interface of the mesh network, the first node including at least one processing circuit, a transmit buffer circuit configured to store data received from the at least one processing circuit, and a first interface circuit configured to transmit, on the first node-to-node interface, data packets comprising data stored in the transmit buffer circuit. The IC further includes a second node of the plurality of nodes coupled to the first node-to-node interface, the second node including a second interface circuit configured to receive the data packets on the first node-to-node interface, and a receive buffer circuit configured to store data from the data packets. The IC further includes a transmit control circuit coupled to the first node and configured to, in response to a first indication of an error in the first interface circuit, generate a transmit error signal, and in response to a receive error signal, reinitialize the first interface circuit to a first initial state. The IC further includes a receive control circuit coupled to the second node and configured to, in response to the transmit error signal or a second indication of an error detected in the second interface circuit, generate the receive error signal to the transmit control circuit, and reinitialize the second interface circuit to a second initial state.

In another exemplary aspect, a method in an integrated circuit (IC) including a plurality of nodes in a mesh network is disclosed. The method includes, in a first node of the plurality of nodes coupled to a first node-to-node interface of the mesh network, storing data received from at least one processing circuit in a transmit buffer circuit, and transmitting, from a first interface circuit, data packets comprising data stored in the transmit buffer circuit. The method further includes, in a second node of the plurality of nodes coupled to the first node-to-node interface, receiving, in a second interface circuit, the data packets from the first interface circuit, and storing the data from the data packets in a receive buffer circuit. The method further includes, in a transmit control circuit coupled to the first node, generating a transmit error signal in response to a first indication of an error detected in the first interface circuit, and reinitializing the first interface circuit in response to a receive error signal. The method further includes, in a receive control circuit coupled to the second node, in response to the transmit error signal or a second indication of an error detected in the second interface circuit, reinitializing the second interface circuit, and generating the receive error signal to the transmit control circuit.

### BRIEF DESCRIPTION OF THE DRAWING FIGURES

The accompanying drawing figures incorporated in and forming a part of this specification illustrate several aspects of the disclosure and, together with the description, serve to explain the principles of the disclosure.

FIG. 1 is a diagram of an exemplary integrated circuit (IC) including nodes that are interconnected by a node-to-node interface in a mesh network and configured to locally reinitialize interface circuits in response to detected errors;

FIG. 2 is a diagram of a region of the IC in FIG. 1 providing more detail of a first node and a second node in which interface circuits may be reinitialized in response to errors;

FIG. 3 is a diagram of an interface circuit in the first node in FIG. 2, provided for reference in a description of a reinitialization controlled by a transmit control circuit in response to errors detected in the interface circuit;

FIG. 4 is a diagram of an interface circuit in the second node in FIG. 2, provided for reference in a description of a reinitialization controlled by a receive control circuit in response to errors detected in the interface circuit;

FIG. 5 is a flowchart of a method of local reinitialization of a node-to-node interface in response to errors detected in an interface circuit;

FIG. 6 is a flowchart of states of reinitialization in an interface circuit in a transmitting node in response to detected errors;

FIG. 7 is a flowchart of states of reinitialization in an interface circuit in a receiving node in response to detected errors; and

FIG. 8 is a block diagram of an exemplary processor-based system that comprises integrated circuit chips that may include nodes that are interconnected by a node-to-node interface in a mesh network and configured to locally reinitialize respective interface circuits in response to detected errors.

### DETAILED DESCRIPTION

With reference to the drawing figures, several exemplary aspects of the present disclosure are described. The word “exemplary” is used herein to mean “serving as an example, instance, or illustration.” Any aspect described herein as “exemplary” is not necessarily to be construed as preferred or advantageous over other aspects.

Exemplary aspects disclosed herein include local interface error recovery for node-to-node transfers in a mesh network on an integrated circuit (IC). Related methods of recovering from errors in node-to-node transfer interfaces are also disclosed. A mesh network in an IC may transfer a data packet from a source node to a destination node through many node-to-node interfaces. When an error occurs in one node-to-node interface, it may be possible to reroute a data packet around the problematic interface, but the interface may remain unusable until the entire IC is reset, reducing overall performance. However, resetting the IC can have a much greater performance impact. An exemplary IC including nodes interconnected in a mesh network may employ a transmit control circuit coupled to a transmit node and a receive control circuit coupled to a receive node to reinitialize interface circuits on both ends of a node-to-node interface in response to a detected error in either a transmit node or a receive node. This allows the IC to correct the error and continue to operate the rest of the IC while the node interface is reinitialized rather than resetting the entire IC. In some examples, errors that can trigger a node to be reinitialized may be in circuits that move the data packets within a node, circuits that control flow of the data packets between nodes, or in data packets themselves.

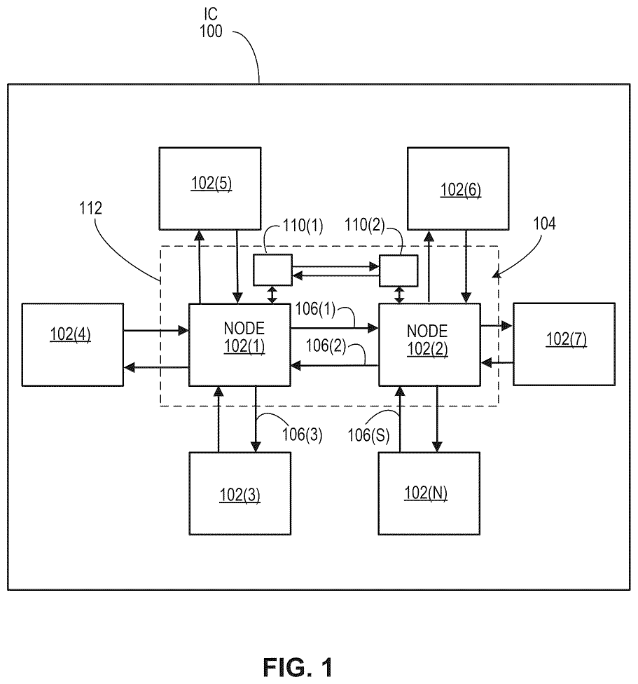

FIG. 1 is a block diagram of an exemplary integrated circuit (IC) 100 including a plurality of nodes 102(1)-102(N) interconnected in a mesh network 104. The nodes 102(1)-102(N) are coupled to node-to-node (NTN) interfaces 106(1)-106(S) of the mesh network 104 through which data packets may be transmitted between the nodes 102(1)-102(N). In an exemplary aspect, when an error is detected while transferring data packets between a first node 102(1) and a second node 102(2) over the NTN interface 106(1), for example, the first and second nodes 102(1) and 102(2) may perform local reinitialization of interface circuits controlling the NTN interface 106(1), rather than triggering a chip-level reset or reboot event, to reduce the impact of the error on IC performance. Local reinitialization may be performed on isolated portions of the circuits in the nodes 102(1)-102(N) while allowing the rest of the circuits in the IC 100 to continue normal operation. Although transfers of data packets through the NTN interfaces would be interrupted during the reinitialization, which may have some effect on overall performance of the IC 100, this would be minor from a performance perspective compared to a reset of the entire IC 100.

FIG. 1 shows the first node 102(1) and the second node 102(2) coupled to the nodes 102(3)-102(N) through the NTN interfaces 106(1)-106(S). The nodes 102(2)-102(N) may also be coupled to each other and to other nodes (not shown) by one or more other NTN interfaces (not shown) in the IC 100 for the purpose of communicating (e.g., transmitting or receiving) data packets through the mesh network 104. In addition, any of the nodes 102(1)-102(N) may be coupled to other interfaces coupled to other circuits, such as accelerators, specialized processing circuits, or cache memory circuits, that are not directly coupled to the mesh network 104.

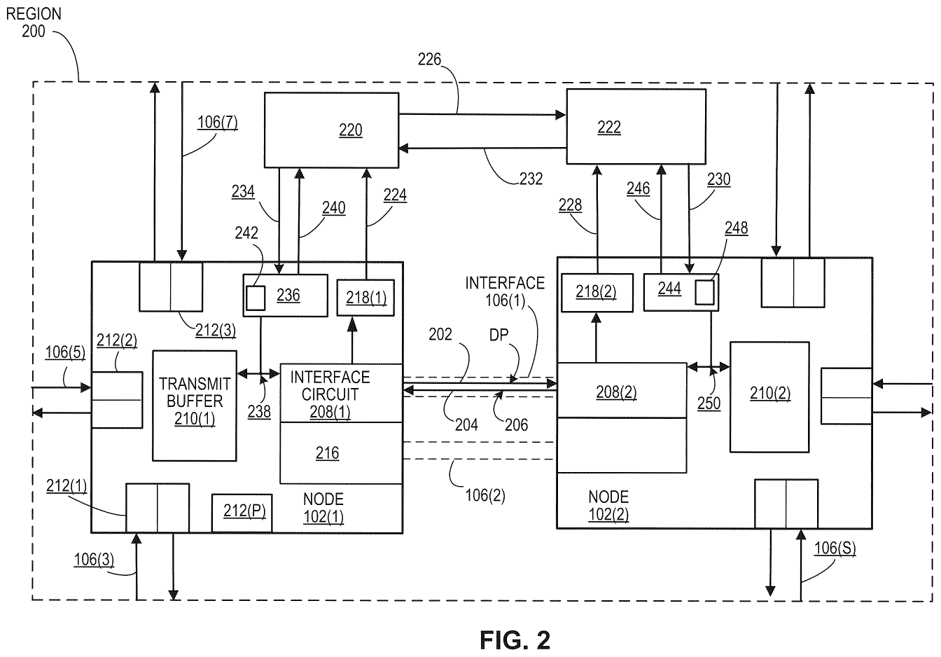

The NTN interface 106(1) in FIG. 1 is described below as an example, representative of the other NTN interfaces 106(2)-106(S), to explain the local reinitialization (recovery) and circuits supporting the local reinitialization of the nodes 102(1)-102(N). The NTN interface 106(1) is a first interface between the first node 102(1) and the second node 102(2). The NTN interface 106(1) is configured to transfer data packets from the first node 102(1) to the second node 102(2). The mesh network 104 includes a second NTN interface 106(2) to transfer data packets in the reverse direction from the second node 102(2) to the first node 102(1). The first and second NTN interfaces 106(1) and 106(2) are independent from each other and may operate simultaneously for bi-directional communication. The IC 100 includes a transmit control circuit 110(1) and a receive control circuit 110(2) to initiate local reinitialization of the first NTN interface 106(1) in response to detection of an error pertaining to the transfer of data packets on the NTN interface 106(1). The error may be in either end of the first NTN interface 106(1) or in the data packet. The transmit control circuit 110(1) is coupled to the first node 102(1) and to the receive control circuit 110(2). The receive control circuit 110(2) is coupled to the second node 102(2) and to the transmit control circuit 110(1). The region 112 of FIG. 1, which includes the first and second nodes 102(1) and 102(2), the first and second NTN interfaces 106(1) and 106(2), the transmit control circuit 110(1), and the receive control circuit 110(2), is described in further detail with reference to FIG. 2.

FIG. 2 is a block diagram of a region 200, which corresponds to the region 112 in FIG. 1, referred to below, including the first node 102(1) and the second node 102(2) to provide details of circuits therein that control a local reinitialization of the NTN interface 106(1) in response to errors detected in the transfer of data packets from the first node 102(1) to the second node 102(2). The NTN interface 106(1) includes a data bus 202, on which data packets DP may be transmitted, and a flow control interface 204, on which the second node 102(2) provides indications 206 of a first number N1 of data packets DP the second node 102(2) can receive.

The first node 102(1) includes a first interface circuit 208(1), a transmit buffer circuit 210(1), and at least one processing circuit 212(1)-212(P) (where P=4 in this example) that processes (e.g., receive) data packets received from other nodes in the network 104. The processing circuits 212(1)-212(P) include interface circuits that transfer/receive data packets on other interfaces NTN 106(3), 106(5), 106(7) and/or other circuits, such as accelerators, special purpose processors, memories, etc. that store data in the transmit buffer circuit 210(1) before it is transmitted to the second node 102(2). Data may be temporarily stored in the buffer circuit 210(1) by any of the processing circuits 212(1)-212(P).

The first node 102(1) also includes NTN interface circuit 216 to control reception of data packets on the NTN interface 106(2). The NTN interface 106(2) is not separately described further herein because it functions in the same manner, though in the opposite direction, as the NTN interface 106(1). The first interface circuit 208(1) is coupled to the NTN interface 106(1) and transmits the data packets DP, which include data previously stored in the transmit buffer circuit 210(1), to the second node 102(2). The first interface circuit 208(1) transmits the data packets DP on the first NTN interface 106(1) from the first node 102(1) to the second node 102(2). The first interface circuit 208(1) may transfer the data as it is received from the transmit buffer circuit 210(1) or may reformat such data in the data packets DP.

The second node 102(2), which is also coupled to the NTN interface 106(1), includes a second interface circuit 208(2) and a receive buffer circuit 210(2). The second interface circuit 208(2) receives the data packets DP on the NTN interface 106(1) and stores the data from the data packets DP in the receive buffer circuit 210(2). At least a portion of the receive buffer circuit 210(2) is dedicated to or allocated for data received by the second interface circuit 208(2) on the NTN interface 106(1) from the first node 102(1). In some examples, the entire receive buffer circuit 210(2) is provided for data received on the NTN interface 106(1). In other examples, portions of the receive buffer circuit 210(2) may be temporarily designated as available to store data from the data packets DP. Since the receive buffer circuit 210(2), or a portion thereof, has a finite capacity, there is a limit to the number of data packets that the second node 102(2) is able to receive from the first node 102(1) and store in the receive buffer circuit 210(2). In the present context, the number N1 of data packets DP the second node 102(2) is able receive is the number N1 of spaces available in the receive buffer circuit 210(2) in which the data packets DP can be stored. Additional data packets DP beyond the first number N1 may be lost because there is no further storage space in which to store them. The number N1 may decrease upon receiving and storing a data packet DP and may increase in response to the second node 102(2) transmitting one of the data packets DP from the receive buffer circuit 210(2) to another intermediate node or a final destination node of the nodes 102(1)-102(N).

The flow of data (e.g., data packets) from the first interface circuit 208(1) in the first node 102(1) to the second interface circuit 208(2) in the second node 102(2) may be controlled based on the indications 206 of the number N1 of data packets DP the second node 102(2) is able to receive. Again, the expression “is able to receive” in this context means that the buffer circuit 210(2), or a portion thereof, has enough unused or available space to store the first number N1 of data packets DP. For example, data packets may be stored in the receive buffer circuit 210(2) in data blocks having a particular size, where each data block may be transmitted from the first interface circuit 208(1) to the second interface circuit 208(2) in a single data packet DP and each data packet DP may contain, for example, a single data block. The space required to store a data block in the receive buffer circuit 210(2) may be referred to as a block of storage. Thus, the second interface circuit 208(2) may provide, for each available block of storage in the receive buffer circuit 210(2), the indication 206 to indicate the first number N1 of data packets DP the second node 102(2) is able receive. Additional data packets, above the first number N1, received in the second node 102(2) may be discarded or lost.

The indication 206 may be provided in various manners. For example, the second node 102(1) may issue the indication 206 a first number N1 times, once for each available block of storage that is unused in the second buffer circuit 210(2). In this example, the first number N1 of times the indication 206 is issued would correspond to the first number N1 of blocks of data that may be stored in the available storage. Alternatively, the indication 206 may be provided to the first node 102(1) as the first number N1 (e.g., in binary form), indicating the first number N1 of blocks of data packets that are approved to be sent from the first node 102(1) to the second node 102(2). The second node 102(2) may send such an indication 206 when there are N1 blocks of storage available in the receive buffer circuit 210(2). Such an indication 206 may be stored and updated based on new indications 206 indicating a change in the amount of space available (unused) in the receive buffer circuit 210(2) for storing data blocks.

The first interface circuit 208(1) receives the indications 206 on the flow control interface 204 and interprets the indication 206 as an approval to send up to, but no more than, the first number N1 of data packets DP. If the transmit buffer circuit 210(1) contains fewer blocks of data than the number N1 approved to be sent to the second node 102(2), then all of the stored blocks of data may be transmitted. The first interface circuit 208(1) keeps track of (e.g., counts) a second number N2 of the data packets actually transmitted from the first node 102(1) to the second node 102(2). The second number N2 is stored and updated as data packets are transmitted. The first interface circuit 208(1) may subtract the second number N2 from the first number N1, with the result indicating an updated first number N1 of data packets the second node 102(2) can receive. The update first number N1 is stored and used to determine how many more data packets may be transmitted from the transmit buffer circuit 210(1)). In other words, the first interface circuit 208(1) may calculate a difference between the first number N1 and the second number N2 and may continue to transmit data packets based on the difference between N1 and N2.

In other situations, the transmit buffer circuit 210(1) may be storing more than the first number N1 of data blocks approved to be sent to the second node 102(2). In this case, the first interface circuit 208(1) is limited to sending only the second number N2 of data packets DP. Subsequently, more data blocks destined for the second node 102(2) may be stored in the transmit buffer circuit 210(1), and, based on the difference between N1 and N2, additional data packets DP are transmitted. Eventually, when the second number N2 of data packets actually transmitted to the second node 102(2) is equal to the first number N1 of data packets approved, the first interface circuit 208(1) stops transmitting data packets DP. The first interface circuit 208(1) is not approved to send any additional data packets until receiving a new or updated indication 206 providing approval for one or more data packets DP to be sent. In this manner, the flow of data packets from the first node 102(1) to the second node 102(2) is controlled.

In a complementary manner, the second buffer circuit 210(2) generates and/or updates the indication 206 of the first number N1 based on blocks of storage available in the receive buffer circuit 210(2). The second interface circuit 208(2) also tracks or counts the second number N2 of data packets received from the first interface circuit 208(1) on the first NTN interface 106(1). The second interface circuit 208(2) may compare the first number N1 to the second number N2 and/or may update the first number N1 based on the second number N2. As noted, the first number N1 and the second number N2 may be tracked, compared, and updated by the first interface circuit 208(1) and by the second interface circuit 208(2).

Binary logic circuits occasionally suffer failures that cause a change of voltage state of a terminal or node. For example, high energy particles may cause a transistor to change state (e.g., “flip”) from a high voltage output to a low voltage output, or vice versa (e.g., from logical “0” to “1” or “1” to “0”). As a result, an error (e.g., unintentional change in a circuit state) may occur in the first interface circuit 208(1) or the second interface circuit 208(2). For example, an error may occur in the tracking, comparison, generation, or storage of the first number N1 or the second number N2. An error indication may be generated based on the first number N1, the second number N2, and the difference between the first number and the second number N2. In the presence of such an error, one or both of the numbers N1 and N2 may be incorrect. As a result, an incorrect number of data packets may be approved for transmission. In this situation, the number of data blocks received in the second node 102(2) may be greater than the space available for storage of data blocks. Consequently, one or more data blocks may be lost. Alternatively, the first interface circuit 208(1) may unnecessarily limit the number of data blocks that are sent to the second node 102(2), which may slow down performance or cause a data error.

Errors may also occur in circuits controlling the transmission or reception of data packets over the first NTN interface 106(1) and in the data packets. Any such errors may be detected in the first interface circuit 208(1) or the second interface circuit 208(2).

Error detection may be performed by checking parity and/or error correction code (ECC) bits associated with multiple data bits or control bits. The first node 102(1) includes an error management circuit 218(1) to monitor the first interface circuit 208(1) for any type of error (e.g., parity or ECC). In some examples, detected errors may be correctable by internal error recovery logic circuits without interruption of normal operation. In other cases, although an error has been detected in a group of bits protected by parity or ECC, the error may be uncorrectable because, for example, it may not be possible to determine which bit or bits has an invalid state. The second node 102(2) includes an error management circuit 218(2) to monitor the second interface circuit 208(2) for errors. For example, the error management circuit 218(2) may generate an indication of an error based on the first number N1 of indications 206, the second number N2 of data packets received, and a result of a comparison between N1 and N2, which may be used to generate the indications 206. In response to detecting an uncorrectable error in an IC, a reboot or reset may be necessary to re-initialize the IC back to a known-good starting state from which normal operation may be resumed. The reinitialization may be initiated in response to an indication by the error management circuit 218(1) or the error management circuit 218(2) that an error (e.g., unrecoverable error) has occurred.

Rebooting an entire IC due to one error has a significant impact on performance and reliability of a system that includes the IC. To reduce such impact, the exemplary IC 100 includes a transmit control circuit 220 and a receive control circuit 222 to handle local recovery from an indication of an error in either the first interface circuit 208(1) or the second interface circuit 208(2). Local recovery, in this context, includes reinitialization of the first NTN interface 106(1), which further includes reinitializing the first interface circuit 208(1) and the second interface circuit 208(2).

The transmit control circuit 220 is coupled to the first node 102(1) and to the receive control circuit 222. Within the first node 102(1), the transmit control circuit 220 is coupled to the error management circuit 218(1) to receive an indication 224 of an error in first interface circuit 208(1). The receive control circuit 222 is coupled to the transmit control circuit 220 and to the error management circuit 218(2).

Upon detecting an error, the error management circuit 218(1) may provide the indication 224 to the transmit control circuit 220, which may respond by generating a transmit error signal 226 to the receive control circuit 222. Whether the receive control circuit 222 receives the transmit error signal 226 or an indication 228 of an error in the second interface circuit 208(2), the receive control circuit 222 responds by initiating a reinitialization of the NTN interface 106(1). This includes providing a second reinitialization signal 230 to the second interface circuit 208(2) and providing a receive error signal 232 to the transmit control circuit 220. In response to receiving the receive error signal 232, the transmit control circuit 220 generates a first reinitialization signal 234.

To control the recovery of the first interface circuit 208(1), the first node 102(1) includes a first recovery circuit 236 that receives the first reinitialization signal 234 from the transmit control circuit 220. In response to the first reinitialization signal 234, the first recovery circuit 236 generates reinitialization control signals 238 to control aspects of the first node 102(1) to prepare for and perform reinitialization of the first interface circuit 208(1). In response to the reinitialization control signals 238, the first recovery circuit 236 disables transmission of the data packets DP on the first interface circuit 208(1) on the first NTN interface 106(1) before reinitializing the first interface circuit 208(1) and re-enables transmission of the data packets DP on the first interface circuit 208(1) on the first NTN interface 106(1) after reinitializing the first interface circuit 208(1).

The first interface circuit 208(1) includes internal circuits, described further below, that are reinitialized to a known-good state (e.g., error free) from which normal operation may resume. The known-good state may be a same known-good state that is achieved in the first interface circuit 208(1) upon reboot or reset of the IC 100 or a different known-good state. The reinitialization of the first interface circuit 208(1) may be referred to as a local reinitialization because the first reinitialization signal 234 may not cause the transmit buffer circuit 210(1), the at least one processing circuits 212(1)-212(P), or the first recovery circuit 236 to be reinitialized. That is, only the first interface circuit 208(1) may be reinitialized in response to the first reinitialization signal 234. The processing circuits 212(1)-212(3) may continue to transmit and/or receive data packets on their respective NTN interfaces 106(3), 106(5), and 106(7) of the mesh network 104, shown in FIG. 1. Since some of the data received in the processing circuits 212(1)-212(3) or generated in the processing circuit 212(P) may need to be transmitted to or through the second node 102(2), those circuits may be forced to pause but remain active while they wait for the reinitialization of the first interface circuit 208(1) to complete before they can resume normal operation.

The first recovery circuit 236 monitors the first interface circuit 208(1) and generates an interface status signal 240 to inform the transmit control circuit 220 of the status of the first interface circuit 208(1). For example, the first recovery circuit 236 may employ the interface status signal 240 to inform the transmit control circuit 220 of whether reinitialization of the first interface circuit 208(1) is complete. The first recovery circuit 236 may include a state machine 242.

The second node 102(2) includes a second recovery circuit 244 that receives the second reinitialization signal 230 and controls the second interface circuit 208(2) to reinitialize (e.g., locally) to a known-good state from which normal operation may resume. The second recovery circuit 244 also generates an interface status signal 246 to inform the receive control circuit 222 of the status of the second interface circuit 208(2). The second reinitialization signal 230 may not cause the second buffer circuit 210(2) or the second recovery circuit 244 to reinitialize. The second recovery circuit 244 reinitializes the second interface circuit 208(2). The second recovery circuit 244 may include a state machine 248 and generate reinitialization control signals 250 to prepare for and perform the reinitialization of the second interface circuit 208(2).

It should be understood that the IC 100 may include additional signals not explicitly mentioned here for communication between the components discussed above and that alternative signals to the ones discussed above may be employed according to design preferences. For example, the first recovery circuit 236 may communicate with the transmit buffer circuit 210(1) or the at least one processing circuit 212(1)-212(P) to block data from the at least one processing circuits 212(1)-212(P) to the transmit buffer circuit 210(1). In some examples, other circuits in the first node 102(1) and the second node 102(2) may also be reinitialized in conjunction with the reinitialization of the first interface circuit 208(1) and the second interface circuit 208(2).

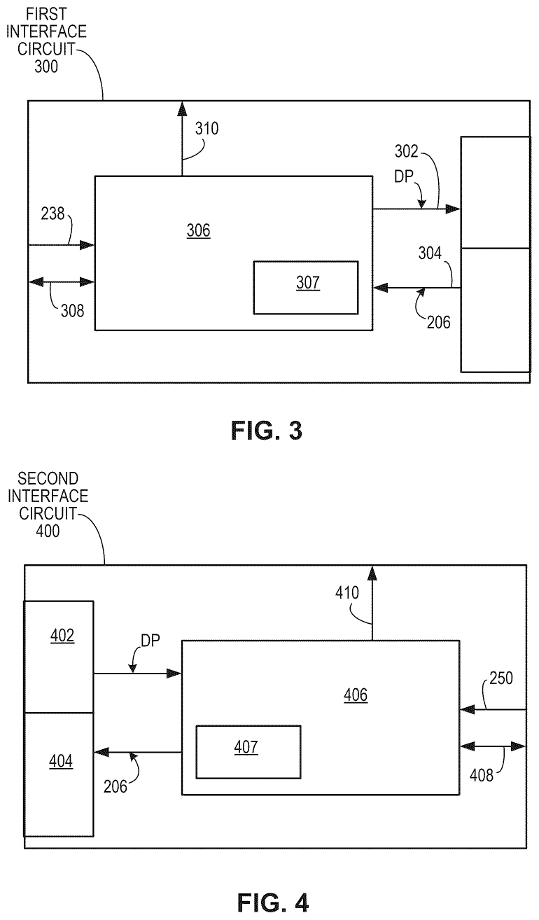

FIG. 3 is a block diagram of a first interface circuit 300, which may be the first interface circuit 208(1) in FIG. 2, provided to show details for reference in the following description of local reinitialization of the interface circuit. Thus, the following description of FIG. 3 will include continuing references to corresponding features in FIGS. 1 and 2. The first interface circuit 300 includes a bus driver circuit 302 that may be coupled to a data bus, such as the data bus 202, to transmit data packets to a receiver node. The interface circuit 300 also includes a flow control receiver circuit 304 coupled to a flow control interface, which may be the flow control interface 204 shown in FIG. 2. The flow control receiver circuit 304 receives the indications 206 of the first number N1 of data packets DP the second node can receive. The bus driver circuit 302 and the flow control receiver circuit 304 may include storage circuits to temporarily store the data packets DP being transmitted and the indications 206 being received.

The first interface circuit 300 includes an interface control circuit 306, which may include a first state machine 307, to control receiving data (e.g., blocks of data) from the transmit buffer circuit 210(1) on a buffer interface 308 and generating data packets DP for transmission by the bus driver circuit 302. The interface control circuit 306 may accept data from the transmit buffer circuit 210(1) in response to the indications 206 received from the second node 102(2) on the flow control receiver circuit 304. The interface control circuit 306 generates reinitialization control signals 238 to inform the transmit buffer circuit 210(1) that the first interface circuit 300 is ready to send a data packet DP through the bus driver circuit 302.

The first interface circuit 300 communicates with the error management circuit 218(1) to provide parity, ECC, and/or other information 310 from which the error management circuit 218(1) may determine that there is an error in the first interface circuit 300. As described above, the error indication 224 is generated to the transmit control circuit 220 in response to an error and the first reinitialization signal 234 is subsequently received from the transmit control circuit 220 in the first recovery circuit 236.

When the first reinitialization signal 234 is received in the first node 102(1) from the transmit buffer circuit 210(1), the first recovery circuit 236 communicates with the first interface circuit 300 by way of reinitialization control signals 238 to prepare for and perform the reinitialization of the first interface circuit 300, which includes reinitializing any storage circuits (e.g., registers, latches, flip-flops, etc.) in the state machine 307 in the interface control circuit 306, the data bus driver circuit 302, and the flow control receiver circuit 304 to a known-good state. Additional signals (not shown) are anticipated and may be included to support communication between the first interface circuit 208(1) and the recovery circuit 236 depending on implementation.

FIG. 4 is a block diagram of a second interface circuit 400, which may be the second interface circuit 208(2) in the second node 102(2) in FIGS. 1 and 2. Thus, the following description of FIG. 4 will include continuing references to corresponding features in FIGS. 1 and 2. The second interface circuit 400 includes a receiver circuit 402 to receive the data packets DP on the data bus 202 and a flow control circuit 404 to send the indications 206 that the second interface circuit 400 is ready to receive data packets DP. The second interface circuit 400 includes an interface control circuit 406 to control transfers of data to the receive buffer circuit 210(2) in FIG. 2. The interface control circuit 406 may include a state machine 407 to control receiving data packets from the receiver circuit 402 and provide data blocks to the receive buffer circuit 210(2) through a buffer interface 408. The interface control circuit 406 determines, based on communication through the buffer interface 408, whether the second interface circuit 400 is ready to receive data blocks and generates the indication 206 accordingly.

The interface control circuit 406 also communicates with the error management circuit 218(2) in FIG. 2 to provide parity, ECC, and other necessary information 410 needed to monitor the second interface circuit 400 for errors. The error management circuit 218(2) generates the indication 228 of an error to the receive control circuit 222 in response to detecting an error. The second recovery circuit 240 receives the second reinitialization signal 230 from the receive control circuit 222 and generates reinitialization signals 412 to prepare for and reinitialize the second interface circuit 400. The reinitialization signals 412 cause the interface control circuit 406, the receiver circuit 402, and the flow control circuit 404 to be reinitialized to a known-good state, which includes any storage circuits therein. The interface control circuit 406 generates status signals 414 to indicate whether reinitialization of the second interface circuit 400 is complete.

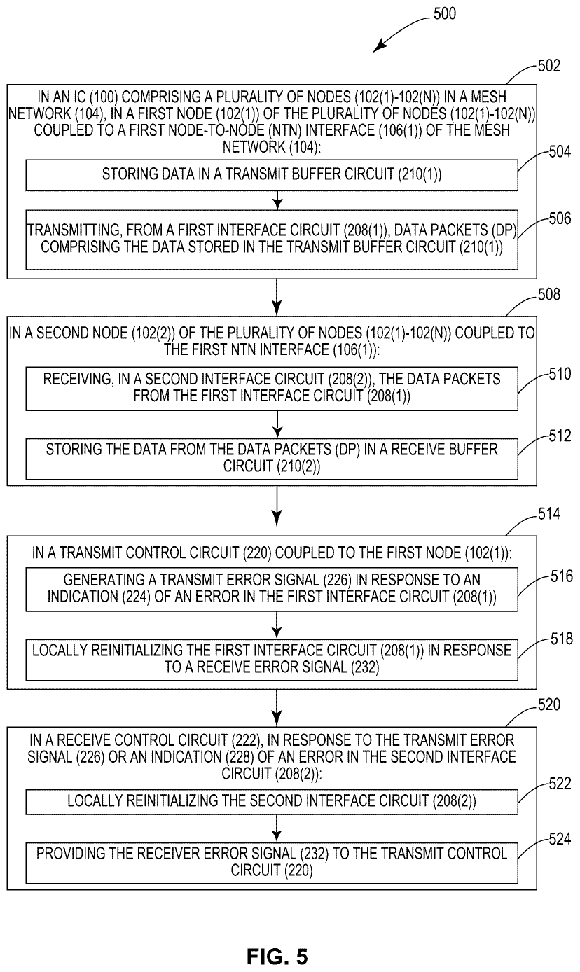

FIG. 5 is a flow chart of a method 500 of in an IC 100 comprising a plurality of nodes 102(1)-102(N) in a mesh network 104, the method comprising: in a first node 102(1) of the plurality of nodes 102(1)-102(N) coupled to a first node-to-node interface 106(1) of the mesh network 104 (block 502): storing data in a transmit buffer circuit 210(1) (block 504); and transmitting, from a first interface circuit 208(1), data packets DP comprising data stored in the transmit buffer circuit 210(1) (block 506). The method comprises, in a second node 102(2) of the plurality of nodes 102(1)-102(N) coupled to the first node-to-node interface 106(1) (block 508):
receiving, in a second interface circuit 208(2), the data packets DP from the first interface circuit 208(1) (block 510); and storing the data from the data packets DP in a receive buffer circuit 210(2) (block 512). The method 500 also includes, in a transmit control circuit 220 coupled to the first node 102(1) (block 514): generating a transmit error signal 226 in response to an indication 224 of an error detected in the first interface circuit 208(1) (block 516); and locally reinitializing the first interface circuit 208(1) in response to a receive error signal 232 (block 518). The method 500 further includes, in a receive control circuit 222 coupled to the second node 102(2), in response to the transmit error signal 226 or an indication 228 of an error detected in the second interface circuit 208(2) (block 520): locally reinitializing the second interface circuit 208(2) (block 522); and
providing the receive error signal 232 to the transmit control circuit 220 (block 524).

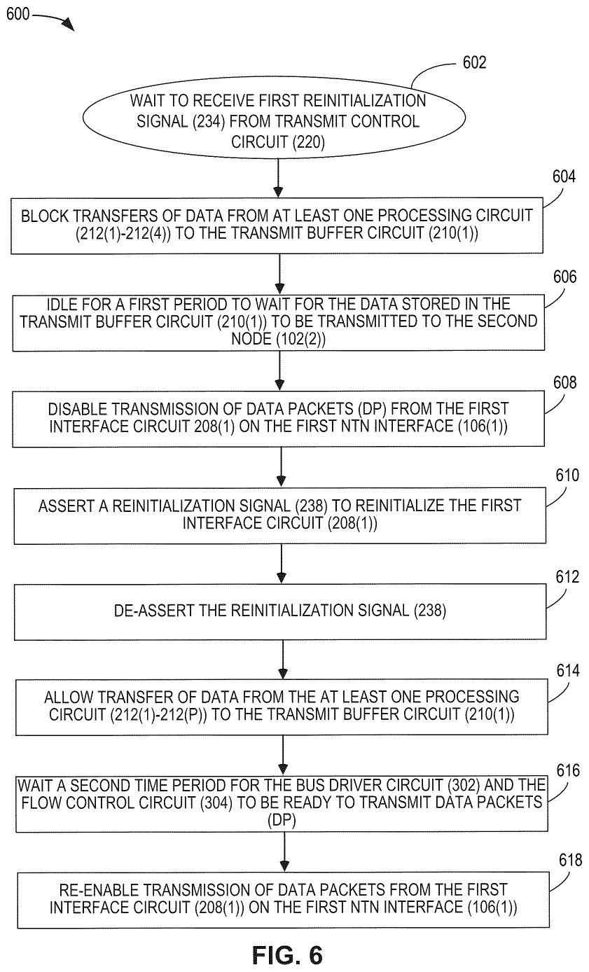

FIG. 6 is a flowchart of a sequence 600 of states of the state machine 242 in the first recovery circuit 236 in the first node 102(1) of FIGS. 1 and 2, for controlling reinitialization of the first interface circuit 208(1) in FIG. 2. The sequence 600 begins at state 602 with waiting to receive the first reinitialization signal 234 from the transmit control circuit 220. Upon receiving the first reinitialization signal 234, the state machine 242 transitions to state 604 and blocks transfers of data from the at least one processing circuit 212(1)-212(P) to the transmit buffer circuit 210(1) so that no more data directed to the second node 102(2) is stored in the transmit buffer circuit 210(1). The sequence 600 idles at state 606 for a first period to wait for the data stored in the transmit buffer circuit 210(1) to be transmitted to the second node 102(2). In some examples, the state machine 242 may wait until it determines that all the data in the transmit buffer circuit 210(1) that is directed to the second node 102(2) has been transmitted to the second node in data packets DP. The sequence 600 of the state machine 242 continues to state 608 to disable transmission of data packets DP from the first interface circuit 208(1) on the first NTN interface 106(1) and then, at state 610, asserts a reinitialization control signal 238 to reinitialize the first interface circuit 208(1). The reinitialization involves resetting registers, latches, flip-flops, and other data storage circuits in the interface control circuit 306, the data bus driver circuit 302, and the flow control receiver circuit 304 to known-good states. The state machine 242 may wait a second period of time at state 610 for the reinitialization of the first interface circuit 208(1) to complete.

At state 612 of the sequence 600, the state machine 242 de-asserts the reinitialization control signal 238 and proceeds to state 614 at which the state machine 242 allows transfers of data from the at least one processing circuit 212(1)-212(P) to the transmit buffer circuit 210(1). At state 616, the state machine 242 waits a second time period for the bus driver circuit 302 and the flow control receiver circuit 304 to recover from the reinitialization and indicate readiness to resume data packet DP transfers. This may include waiting for indications 206 that the second node 102(2) is also ready to receive data packets DP. At state 618, the state machine 242 re-enables transmission of data packets DP from the first interface circuit 208(1) on the first NTN interface 106(1).

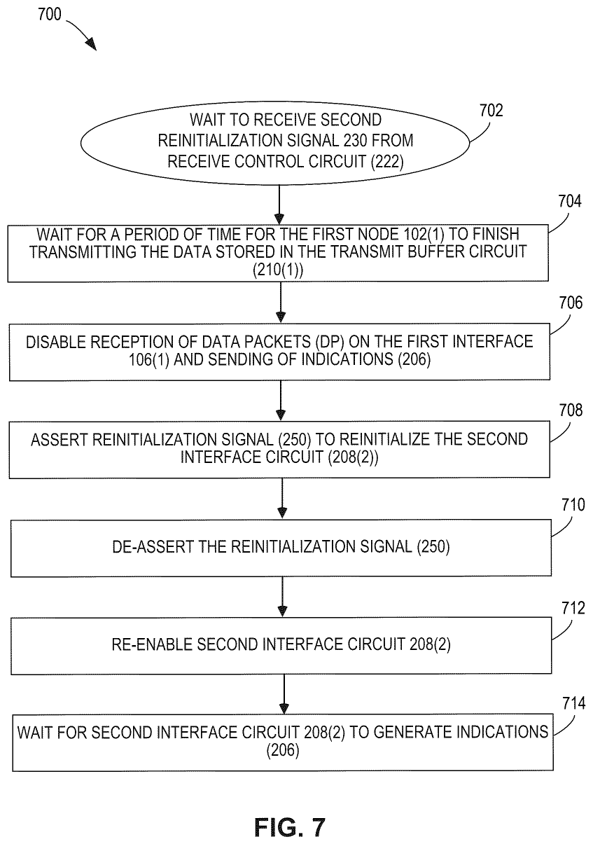

FIG. 7 is a flowchart of a sequence 700 of the state machine 242 in FIG. 2 for controlling reinitialization of the second interface circuit 208(2) in the second node 102(2). The sequence 700 begins at state 702 with waiting to receive the second reinitialization signal 230 from the receive control circuit 222. Upon receiving the second reinitialization signal 230, the state machine 242 transitions to state 704 to wait a period of time for the first node 102(2) to finish transmitting the data stored in the transmit buffer circuit 210(1). In this regard, during this period, if there continues to be space in the receive buffer circuit 210(2), the second node 102(2) generates indications 206 that the second interface circuit 208(2) is ready to receive data packets DP. Since the first node 102(1) is blocking reception of new data into the transmit buffer circuit 210(1), the data stored in the transmit buffer circuit 210(1) will eventually be transmitted.

In state 706, the state machine 242 disables reception of data packets DP on the first NTN interface 106(1) and the sending of any more indications 206. This may include disabling the receiver circuit 402 and the flow control circuit 404. At state 708, the state machine 242 asserts the reinitialization control signal 250 to reinitialize the second interface circuit 208(2), including the storage circuits in the interface control circuit 406, the receiver circuit 402, and the flow control circuit 404. The state machine 242 may pause at state 708 to achieve the reinitialization of all storage circuits to a known-good state. The state machine 242 proceeds after a period of time at state 708 to state 710 at which the reinitialization control signal 250 is de-asserted. The period of time of the pause at state 708 may be programmable. At state 712, the second interface circuit 208(2) is re-enabled, which includes re-enabling the interface control circuit 406, the receiver circuit 402, and the flow control circuit 404. At state 714, the state machine 242 waits for the second interface circuit 208(2) to be ready for data packet DP transfers and proceeds to generate indications 206 that the second node 102(2) is ready to receive data packets DP.

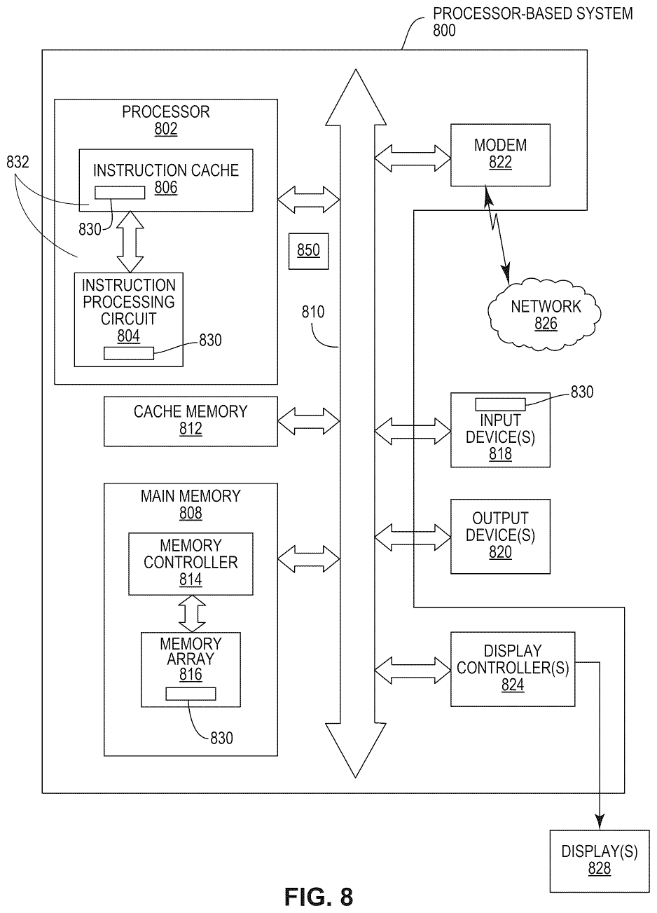

FIG. 8 is a block diagram of an exemplary processor-based system 800 that includes a processor 802 (e.g., a microprocessor), including an instruction processing circuit 804. The processor-based system 800 may include integrated circuits on an electronic board or card, such as a printed circuit board (PCB), in a server, a personal computer, a desktop computer, a laptop computer, a personal digital assistant (PDA), a computing pad, a mobile device, or any other device, and may represent, for example, a server, or a user's computer. In this example, the processor-based system 800 includes the processor 802. The processor 802 represents one or more general-purpose processing circuits, such as a microprocessor, central processing unit, or the like. More particularly, the processor 802 may be an EDGE instruction set microprocessor or other processor implementing an instruction set that supports explicit consumer naming for communicating produced values resulting from the execution of producer instructions.

The processor 802 is configured to execute instructions for performing the operations and steps discussed herein. In this example, the processor 802 includes an instruction cache 806 for temporary, fast access memory storage of instructions accessible by the instruction processing circuit 804. Fetched or prefetched instructions from a memory, such as a main memory 808, over a system bus 810, are stored in the instruction cache 806. Data may be stored in a cache memory 812 coupled to the system bus 810 for low-latency access by the processor 802. The instruction processing circuit 804 is configured to process instructions fetched into the instruction cache 806 and process the instructions for execution.

The processor 802 and the main memory 808 are coupled to the system bus 810 and can intercouple peripheral devices included in the processor-based system 800. As is well known, the processor 802 communicates with these other devices by exchanging address, control, and data information over the system bus 810. For example, the processor 802 can communicate bus transaction requests to a memory controller 814 in the main memory 808 as an example of a slave device. Although not illustrated in FIG. 8, multiple system buses 810 could be provided, wherein each system bus 810 constitutes a different fabric. In this example, the memory controller 814 is configured to provide memory access requests to a memory array 816 in the main memory 808. The memory array 816 is comprised of an array of storage bit cells for storing data. The main memory 808 may be a read-only memory (ROM), flash memory, dynamic random-access memory (DRAM), such as synchronous DRAM (SDRAM), etc. and/or static memory (e.g., flash memory, SRAM, etc.), as non-limiting examples.

Other devices can be connected to the system bus 810. As illustrated in FIG. 8, these devices can include the main memory 808, one or more input device(s) 818, one or more output device(s) 820, a modem 822, and one or more display controllers 824, as examples. The input device(s) 818 can include any type of input device, including but not limited to input keys, switches, voice processors, etc. The output device(s) 820 can include any type of output device, including but not limited to audio, video, other visual indicators, etc. The modem 822 can be any device configured to allow an exchange of data to and from a network 826. The network 826 can be any type of network, including but not limited to a wired network (e.g., ethernet) or wireless network, a private or public network, a local area network (LAN), a wireless local area network (WLAN), a wide area network (WAN), a BLUETOOTH™ network, and the Internet. The modem 822 can be configured to support any type of communications protocol desired. The processor 802 may also be configured to access the display controller(s) 824 over the system bus 810 to control information sent to one or more displays 828. The display(s) 828 can include any type of display, including but not limited to a cathode ray tube (CRT), a liquid crystal display (LCD), a plasma display, etc.

The processor-based system 800 in FIG. 8 may include a set of instructions 830 to be executed by the processor 802 for any application desired according to the instructions. The instructions 830 may be stored in the main memory 808, the processor 802, and/or the instruction cache 806 as examples of a non-transitory computer-readable medium 832. The instructions 830 may also reside, completely or at least partially, within the main memory 808 and/or within the processor 802 during their execution. The instructions 830 may further be transmitted or received over the network 826 via the modem 822, such that the network 826 includes the computer-readable medium 832.

While the computer-readable medium 832 is shown in an exemplary embodiment to be a single medium, the term “computer-readable medium” should be taken to include a single medium or multiple media (e.g., a centralized or distributed database and/or associated caches and servers) that store the one or more sets of instructions. The term “computer-readable medium” shall also be taken to include any medium that is capable of storing, encoding, or carrying a set of instructions for execution by the processing device and that causes the processing device to perform any one or more of the methodologies of the embodiments disclosed herein. The term “computer-readable medium” shall accordingly be taken to include, but not be limited to, solid-state memories, optical medium, and magnetic medium.

The embodiments disclosed herein include various steps. The steps of the embodiments disclosed herein may be formed by hardware components or may be embodied in machine-executable instructions, which may be used to cause a general-purpose or special-purpose processor programmed with the instructions to perform the steps. Alternatively, the steps may be performed by a combination of hardware and software.

The embodiments disclosed herein may be provided as a computer program product or software that may include a machine-readable medium (or a computer-readable medium) having stored thereon instructions, which may be used to program a computer system (or other electronic devices) to perform a process according to the embodiments disclosed herein. A machine-readable medium includes any mechanism for storing or transmitting information in a form readable by a machine (e.g., a computer). For example, a machine-readable medium includes a machine-readable storage medium (e.g., ROM, random access memory (“RAM”), a magnetic disk storage medium, an optical storage medium, flash memory devices, etc.), and the like.

Unless specifically stated otherwise and as apparent from the previous discussion, it is appreciated that throughout the description, discussions utilizing terms such as “processing,” “computing,” “determining,” “displaying,” or the like refer to the action and processes of a computer system, or similar electronic computing device, that manipulates and transforms data and memories represented as physical (electronic) quantities within the computer system's registers into other data similarly represented as physical quantities within the computer system memories or registers or other such information storage, transmission, or display devices.

The algorithms and displays presented herein are not inherently related to any particular computer or other apparatus. Various systems may be used with programs in accordance with the teachings herein, or it may prove convenient to construct more specialized apparatuses to perform the required method steps. The required structure for a variety of these systems will appear from the description above. In addition, the embodiments described herein are not described with reference to any particular programming language. It will be appreciated that a variety of programming languages may be used to implement the teachings of the embodiments as described herein.

Those of skill in the art will further appreciate that the various illustrative logical blocks, modules, circuits, and algorithms described in connection with the embodiments disclosed herein may be implemented as electronic hardware, instructions stored in memory or in another computer-readable medium and executed by a processor or other processing device, or combinations of both. Memory disclosed herein may be any type and size of memory and may be configured to store any type of information desired. To clearly illustrate this interchangeability, various illustrative components, blocks, modules, circuits, and steps have been described above generally in terms of their functionality. How such functionality is implemented depends on the particular application, design choices, and/or design constraints imposed on the overall system. Skilled artisans may implement the described functionality in varying ways for each particular application, but such implementation decisions should not be interpreted as causing a departure from the scope of the present embodiments.

The various illustrative logical blocks, modules, and circuits described in connection with the embodiments disclosed herein may be implemented or performed with a processor, a Digital Signal Processor (DSP), an Application Specific Integrated Circuit (ASIC), a Field Programmable Gate Array (FPGA), or other programmable logic device, a discrete gate or transistor logic, discrete hardware components, or any combination thereof designed to perform the functions described herein. Furthermore, a controller may be a processor. A processor may be a microprocessor, but in the alternative, the processor may be any conventional processor, controller, microcontroller, or state machine. A processor may also be implemented as a combination of computing devices (e.g., a combination of a DSP and a microprocessor, a plurality of microprocessors, one or more microprocessors in conjunction with a DSP core, or any other such configuration).

The embodiments disclosed herein may be embodied in hardware and in instructions that are stored in hardware and may reside, for example, in RAM, flash memory, ROM, Electrically Programmable ROM (EPROM), Electrically Erasable Programmable ROM (EEPROM), registers, a hard disk, a removable disk, a CD-ROM, or any other form of computer-readable medium known in the art. An exemplary storage medium is coupled to the processor such that the processor can read information from and write information to the storage medium. In the alternative, the storage medium may be integral to the processor. The processor and the storage medium may reside in an ASIC. The ASIC may reside in a remote station. In the alternative, the processor and the storage medium may reside as discrete components in a remote station, base station, or server.

It is also noted that the operational steps described in any of the exemplary embodiments herein are described to provide examples and discussion. The operations described may be performed in numerous different sequences other than the illustrated sequences. Furthermore, operations described in a single operational step may actually be performed in a number of different steps. Additionally, one or more operational steps discussed in the exemplary embodiments may be combined. Those of skill in the art will also understand that information and signals may be represented using any of a variety of technologies and techniques. For example, data, instructions, commands, information, signals, bits, symbols, and chips that may be referenced throughout the above description may be represented by voltages, currents, electromagnetic waves, magnetic fields, optical fields, or particles, or any combination thereof.

Unless otherwise expressly stated, it is in no way intended that any method set forth herein be construed as requiring that its steps be performed in a specific order. Accordingly, where a method claim does not actually recite an order to be followed by its steps, or it is not otherwise specifically stated in the claims or descriptions that the steps are to be limited to a specific order, it is in no way intended that any particular order be inferred.

It will be apparent to those skilled in the art that various modifications and variations can be made without departing from the spirit or scope of the invention. Since modifications, combinations, sub-combinations, and variations of the disclosed embodiments incorporating the spirit and substance of the invention may occur to persons skilled in the art, the invention should be construed to include everything within the scope of the appended claims and their equivalents.

What is claimed is:

1. An integrated circuit (IC), comprising:
a plurality of nodes interconnected in a mesh network;
a first node of the plurality of nodes coupled to a first node-to-node interface of the mesh network, the first node comprising:
at least one processing circuit;
a transmit buffer circuit configured to store data received from the at least one processing circuit; and
a first interface circuit configured to transmit, on the first node-to-node interface, data packets comprising the data stored in the transmit buffer circuit;
a second node of the plurality of nodes coupled to the first node-to-node interface, the second node comprising:
a second interface circuit configured to receive the data packets on the first node-to-node interface; and
a receive buffer circuit configured to store the data from the data packets;
a transmit control circuit coupled to the first node and configured to:
in response to a first indication of an error in the first interface circuit, generate a transmit error signal; and
in response to a receive error signal, reinitialize the first interface circuit to a first initial state; and
a receive control circuit coupled to the second node and configured to, in response to the transmit error signal or a second indication of an error detected in the second interface circuit:
generate the receive error signal to the transmit control circuit; and
reinitialize the second interface circuit to a second initial state.

2. The IC of claim 1, wherein the transmit control circuit is further configured to, in response to the receive error signal, generate a reinitialization signal to the first node to:
disable transmission of the data packets from the first interface circuit on the first node-to-node interface before reinitializing the first interface circuit to the first initial state and
re-enable transmission of the data packets from the first interface circuit on the first node-to-node interface.

3. The IC of claim 2, wherein to disable transmission of the data packets from the first interface circuit on the first node-to-node interface, the transmit control circuit is further configured to:
block data from the at least one processing circuit to the transmit buffer circuit; and
determine that the data stored in the transmit buffer circuit is transmitted to the second node.

4. The IC of claim 2, wherein to re-enable transmission of the data packets from the first interface circuit on the first node-to-node interface, the transmit control circuit is further configured to:
allow transfers of data from the at least one processing circuit to the transmit buffer circuit; and
transmit, on the first node-to-node interface, the data packets comprising data stored in the transmit buffer circuit in response to a third indication, from the second interface circuit of the second node, of a first number of data packets the second node is able to receive.

5. The IC of claim 4, wherein the receive control circuit is further configured to, in response to the transmit error signal or the second indication of an error detected in the second interface circuit:
block reception of the data packets on the first node-to-node interface to the second interface circuit;
reinitialize the second interface circuit to the second initial state; and
re-enable reception of the data packets on the first node-to-node interface to the second interface circuit.

6. The IC of claim 5, wherein to block reception of data packets on the first node-to-node interface to the second interface circuit, the receive control circuit is further configured to:
idle for a first period to allow transmission of the data packets on the first node to complete; and
block the second interface circuit from sending the third indication of the first number of data packets the second node can receive.

7. The IC of claim 5, wherein to re-enable reception of data packets on the first node-to-node interface to the second interface circuit, the receive control circuit is further configured to allow the second interface circuit to provide the third indication of the first number of data packets the second node is able to receive.

8. The IC of claim 4, wherein:
the first interface circuit is further configured to:
receive the third indication of the first number of data packets the second node is able to receive;
update and store the first number based on the third indication;
update and store a second number of the data packets transmitted to the second node; and
transmit data packets based on a calculated difference between the first number and the second number; and
the first node further comprises a first error detection circuit configured to generate the first indication of an error in the first interface circuit based on an error detected in the first number, the second number, or the calculated difference.

9. The IC of claim 4, wherein:
the second interface circuit is further configured to:
generate the third indication based on buffer space in the receive buffer circuit;
track a second number of the data packets received from the first node; and
compare the second number to the first number; and
the second node further comprises a second error detection circuit configured to generate the second indication of an error in the second interface circuit based on an error detected in the first number, the second number, or a result of the comparison.

10. The IC of claim 1, further comprising:
a second transmit control circuit coupled to the second node; and
a second receive control circuit coupled to the first node,
wherein the second node is further configured to transmit data packets to the first node on a second node-to-node interface of the mesh network.

11. The IC of claim 1, wherein a first processing circuit of the at least one processing circuit in the first node comprises:
a third interface circuit configured to receive data packets from a third node on a third node-to-node interface of the mesh network;
a third transmit control circuit coupled to the third node; and
a third receive control circuit coupled to the first node.

12. The IC of claim 1, wherein:
a fourth interface circuit in the first node is configured to transmit data packets to a fourth node on a fourth interface of the mesh network;
the transmit control circuit is configured to:
in response to a fourth indication of an error in the fourth interface circuit, generate a fourth error signal;
receive a fourth recovery signal; and
in response to the fourth recovery signal, reinitialize the fourth interface circuit; and
the IC further comprises a fourth receive control circuit coupled to the fourth node and configured to, in response to the fourth error signal or a fifth indication of an error in a fifth interface circuit in the fourth node:
reinitialize the fifth interface circuit; and
generate a fourth local reset signal to the first transmit control circuit.

13. A method in an integrated circuit (IC) comprising a plurality of nodes in a mesh network, the method comprising:
in a first node of the plurality of nodes coupled to a first node-to-node interface of the mesh network:
storing data received from at least one processing circuit in a transmit buffer circuit; and
transmitting, from a first interface circuit, data packets comprising data stored in the transmit buffer circuit;
in a second node of the plurality of nodes coupled to the first node-to-node interface:
receiving, in a second interface circuit, the data packets from the first interface circuit; and
storing the data from the data packets in a receive buffer circuit;
in a transmit control circuit coupled to the first node:
generating a transmit error signal in response to a first indication of an error detected in the first interface circuit; and
reinitializing the first interface circuit in response to a receive error signal; and
in a receive control circuit coupled to the second node, in response to the transmit error signal or a second indication of an error detected in the second interface circuit:
reinitializing the second interface circuit; and
generating the receive error signal to the transmit control circuit.

14. The method of claim 13, further comprising, in the transmit control circuit, in response to the receive error signal:
disabling transmission of data packets from the first interface circuit on the first node-to-node interface; and
re-enabling transmission of data packets from the first interface circuit on the first node-to-node interface.

15. The method of claim 14, wherein disabling transmission of data packets on the first node-to-node interface from the first interface circuit further comprises:
blocking reception of data from the at least one processing circuit in the transmit buffer circuit; and
determining that data stored in the transmit buffer circuit is transmitted to the second node.

16. The method of claim 14, wherein re-enabling transmission of data packets on the first node-to-node interface from the first interface circuit further comprises, in the transmit control circuit:
allowing transfers of data from the at least one processing circuit to the transmit buffer circuit; and
transmitting, on the first node-to-node interface, data packets comprising data stored in the transmit buffer circuit in response to a third indication, from the second interface circuit of the second node, indicating a first number of data packets the second node is able to receive.

17. The method of claim 16, further comprising, in the receive control circuit, in response to the transmit error signal or the second indication of an error detected in the second interface circuit:
blocking reception of data packets on the first node-to-node interface to the second interface circuit;
reinitializing the second interface circuit to a second initial state; and
re-enabling reception of data packets on the first node-to-node interface to the second interface circuit.

18. The method of claim 17, wherein blocking reception of data packets on the first node-to-node interface to the second interface circuit further comprises:
idling for a first period to allow transmission of data packets on the first node to terminate; and
blocking the second interface circuit from sending the third indication indicating the first number of data packets the second node is able to receive.

19. The method of claim 16, further comprising:
receiving the third indication of the first number of data packets the second node is able to receive;
updating and storing the first number based on the third indication;
updating and storing a second number of the data packets transmitted to the second node;
transmitting data packets based on a calculated difference between the first number and the second number; and
generating the first indication of an error in the first interface circuit based on an error detected in the first number, the second number, or the calculated difference.

20. The method of claim 13, further comprising, in the second interface circuit:
generating a third indication based on buffer space in the receive buffer circuit;
tracking a second number of the data packets received from the first node;
comparing the second number to the first number; and
generating the second indication of an error in the second interface circuit based on an error detected in the first number, the second number, or the comparison.
